(19) United States
(12) Patent Application Publication
(10) Pub. No.: US 2014/0007718 A1
(43) Pub. Date: Jan. 9, 2014

(54) LIFTING DEVICE FOR A TOOL

(71) Applicant: Jorg von Seggern, Oldenburg (DE)

(72) Inventor: Jorg von Seggern, Oldenburg (DE)

(73) Assignee: Jorg von Seggern Maschinenbau GmbH, Oldenburg (DE)

(21) Appl. No.: 14/000,125

(22) PCT Filed: Feb. 17, 2012
(86) PCT No.: PCT/DE12/00148

§ 371 Date: Sep. 19, 2013

(30) Foreign Application Priority Data
Feb. 18, 2011 (DE) 10 2011 011 560.9

(51) Int. Cl. B30B 1/14; F16H 21/50

(52) U.S. Cl. CPC B30B 1/14; F16H 21/50
USPC 74/89

(57) ABSTRACT

The invention relates to a lifting device for a tool, in particular for a lower tool of a deep drawing machine or traysealer, having a framework, at least one tool-receiving portion that is supported in the framework in a liftable manner, and at least one displacement transducer that is arranged between the framework and the tool receiving portion. The framework and this tool receiving portion are connected to each other via at least one knee joint rod assembly, said displacement transducer having at least one crank drive that acts on the knee joint rod assembly. The crank drive has two end positions, each of which is formed in the region of a dead center, and the knee joint rod assembly has an extended dead center position, said extended dead center position of the knee joint rod assembly being formed in one of the dead center positions of the crank drive.

The invention pertains to a lifting device for a tool, particularly for a lower tool of a thermoformer or traysealer, with a framework, at least one tool receptacle that is liftably held in the framework and at least one displacement transducer that is arranged between the framework and the tool receptacle.

In conventional lifting devices, the displacement transducers are realized in the form of pneumatically or hydraulically actuated lifting cylinders, the cylinder capacities of which are dimensioned based on the maximum operating pressures exerted upon the tool. The operating pressures serve, in particular, for carrying out forming, welding or separating processes. Duty to the high operating pressures required for many manufacturing processes, the lifting cylinders have correspondingly large cylinder capacities. Consequently, the operating speed of conventional lifting devices is substantially limited by the performance of the pneumatic or hydraulic valves.

The invention is therefore based on the objective of disclosing a lifting device of the initially cited type, the operating speed of which is significantly increased at identical operating pressures.

According to the invention, this objective is attained with a lifting device with the characteristics of Claim 1. Advantageous enhancements of the invention are disclosed in the dependent claims that refer to Claim 1.

The inventive lifting device is characterized in that the framework and the tool receptacle are connected to one another by means of at least one toggle lever assembly, and in that the displacement transducer features at least one crank drive that engages on the toggle lever assembly. The toggle lever assembly utilizes the so-called toggle lever effect, according to which it is capable of diverting operating pressures introduced into the tool receptacle due to thermoforming or sealing processes directly into the framework pasts the displacement transducer when the toggle lever is completely extended. In this way, the displacement transducer only needs to be rated for a load characteristic that describes a lifting motion of the tool receptacle and excludes any operating pressures. Heavy-duty displacement transducers that counteract the operating pressures introduced into the tool receptacle are advantageously no longer required. The crank drive engaging on the toggle lever assembly serves for converting a driving torque into the highest possible thrust to be applied to the toggle link of the toggle lever assembly for a lifting motion of the tool receptacle. The driving torque can be advantageously transmitted to the crankshaft of the crank drive by means of simple driveshafts. Heavy-duty lifting cylinders that only run with slow operating speeds are advantageously no longer required. According to a first enhancement of the invention, the crank drive has two and positions that are respectively realized in the region of a dead center. These and positions ensure minimal starting torques such that fast operating speeds of the inventive device can be achieved with particularly low driving towards.

According to another enhancement of the invention, the toggle lever assembly has an approximately extended end position, wherein the extended end position of the toggle lever assembly is realized in one of the end positions of the crank drive. Due to this association of the end positions of the toggle lever assembly and the crank drive that are respectively bound to dead center positions, an advantageous operating position is created, in which neither operating forces introduced into the tool receptacle due to thermoforming or sealing processes nor driving torques introduced into the crank drive due to starting processes can lead to mechanical stress on the displacement transducer.

It is furthermore proposed that the toggle lever assembly has a bent end position, wherein the bent end position of the toggle lever assembly is realized in the other dead center position of the crank drive. The bent end position of the toggle lever assembly is advantageously defined as an idle position, from which the tool receptacle can be displaced with higher acceleration than from its dead center position that defines the operating position. In order to achieve the fastest operating speeds possible, the toggle lever assembly preferably has a deflection angle of 90° in its bent end position.

According to a particularly advantageous enhancement of the invention, the crank drive features at least one crankshaft, as well as two connecting rods that are coupled to the crankshaft by means of a ball-and-socket joint. The ball-and-socket joints make it possible for the connecting rods to follow their points of engagement that lie on the toggle lever assembly and are naturally moved along a circular path. However, the scope of the invention also includes embodiments, in which the ball-and-socket joints are replacement with universal joints.

The points of engagement between the connecting rods and the toggle lever assembly are advantageously produced by respectively connecting the ends of the connecting rods that face away from the crankshaft and one toggle link of the toggle lever assembly into a universal joint. However, it would also be conceivable, in principle, to respectively connect the ends of the connecting rods and one toggle link of the toggle lever assembly into a ball-and-socket joint. A particularly low stress on the crankshaft bearings is achieved due to the fact that the ball-and-socket joints feature crank pins that are symmetrically distributed over the circumference of the crankshaft and the moving paths of which extend in a common plane of rotation. In order to prevents the connecting rods from colliding with one another along their moving paths between the end positions in an arrangement of this type, they have an arc-shaped, crescent-shaped or double-elbowed longitudinal extent. In the buckled end position of the crank drive, the bow-shaped longitudinal extent allows the connecting rods to engaged into one another such that their collision is prevented.

According to another enhancement of the invention, it is proposed that the crank drive in assigned at least one step motor that is connected to its crankshaft in order to achieve particularly fast operating speeds. Step motors advantageously make it possible to quickly adjust defined end positions in a positionally accurate and directionally variable fashion. However, it is particularly preferred to realized the step motor in the form of a high-torque motor that in the form of a permanently excited multi-pole synchronous motor advantageously has high torque densities in the range of low and medium speeds.

In order to prevent horizontal play, the framework and the tool receptacle liftably held therein are connected to one another by means of a vertical guide. The vertical guide features, for example, telescopic guides that define the edges of the framework.

According to a particularly advantageous enhancement of the invention, the toggle lever assembly features at least two toggle links, wherein the rotational axis of the crank drive and the link axes of the toggle links extend perpendicular to one another.

Other inventive characteristics result from an exemplary embodiment of the invention that is illustrated in the drawings. In these drawings:

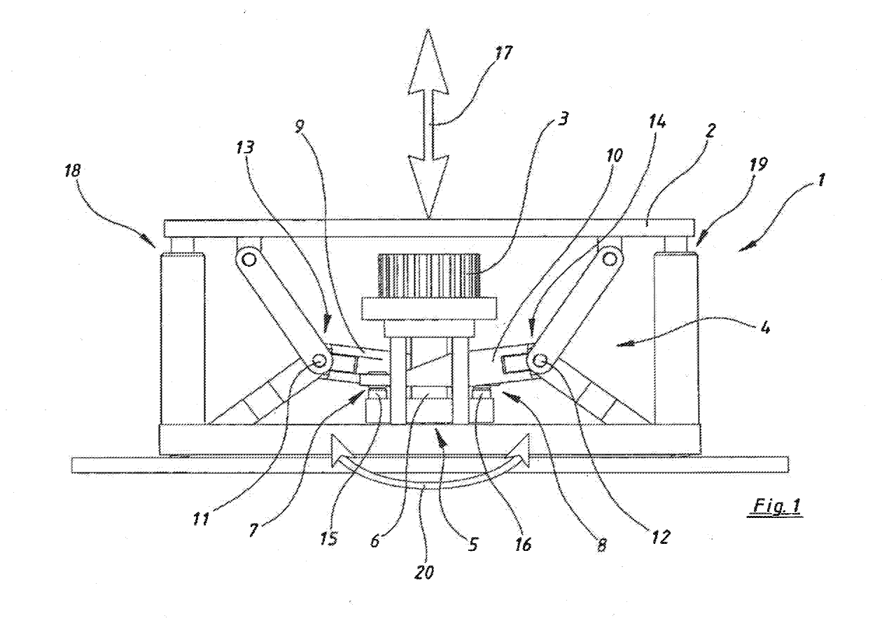

FIG. 1 shows a side view of the inventive lifting device in an idle position;

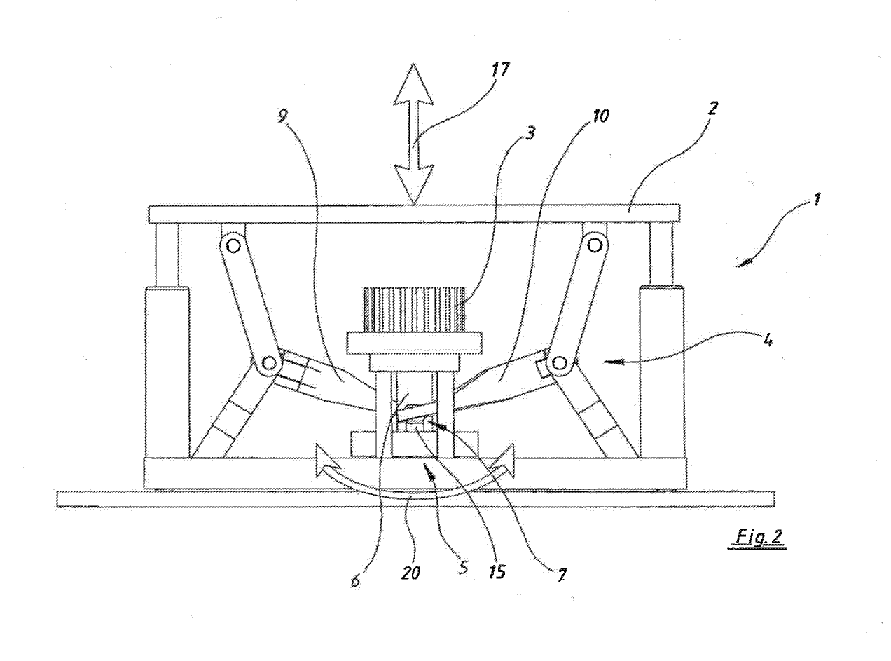

FIG. 2 shows a side view of the lifting device during a lifting motion;

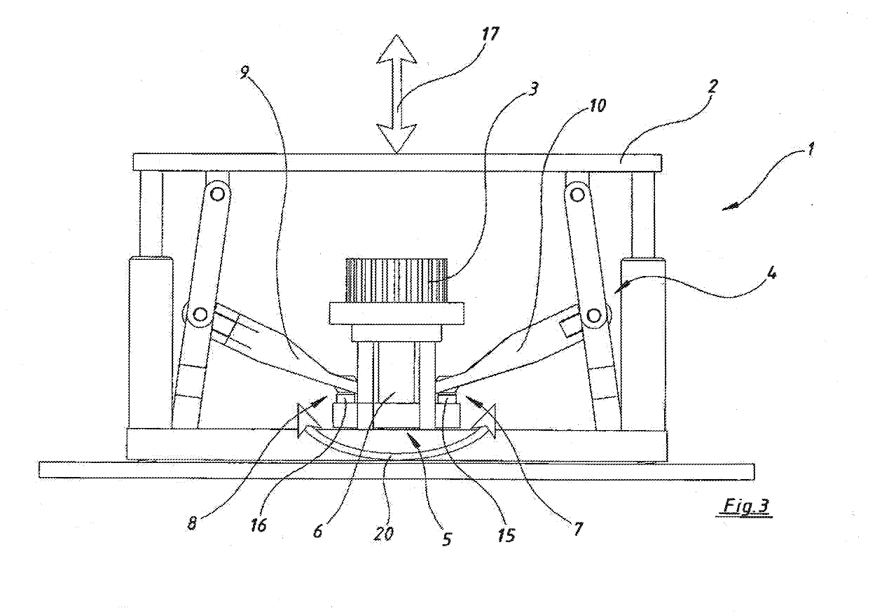

FIG. 3 shows a side view of the lifting device in an operating position, and

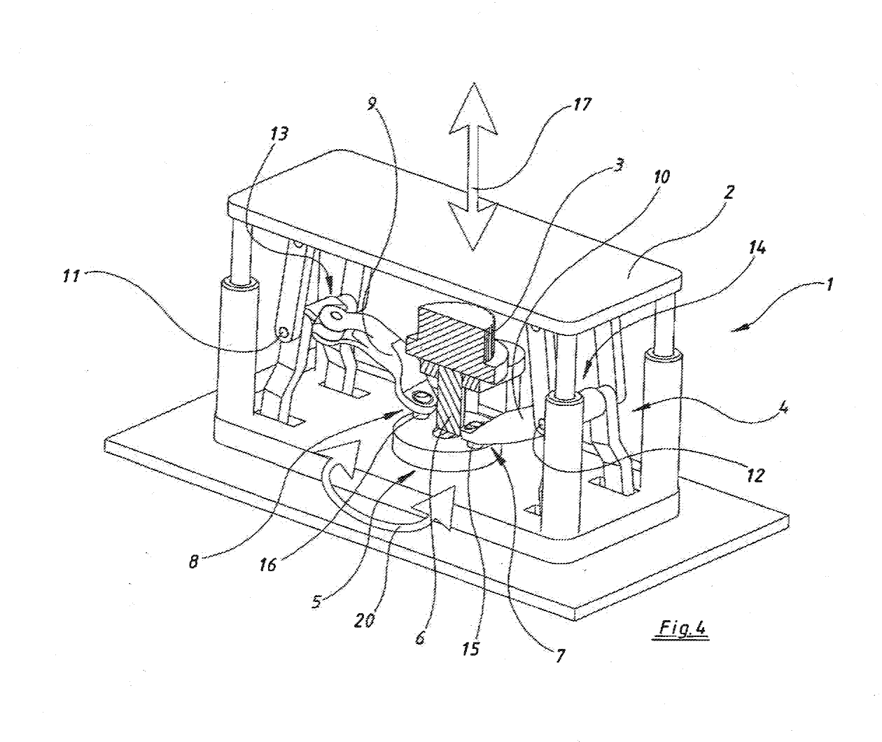

FIG. 4 shows a perspective representation of the lifting device in the operating position according to FIG. 3.

FIG. 1 shows a perspective representation of the inventive lifting device in an operating position. The lifting device features a framework 1, a tool receptacle 2 that is liftably held in the framework 1 and a displacement transducer 3 that is arranged between the framework 1 and the tool receptacle 2. The framework 1 and the tool receptacle 2 are connected to one another by means of a toggle lever assembly 4. The displacement transducer 3 is realized in the form of a step motor and features a crank drive 5 that engages on the toggle lever assembly 4 and in the operating position shown is in a bent end position that is realized in the region of its buckled dead center. The crank drive 5 features a crankshaft 6 that is realized in the form of a crank disk, as well as two connecting rods 9, 10 that a respectively coupled to the crankshaft 6 by means of a ball-and-socket joint 7, 8. The ends of the connecting rods 9, 10 that face away from the crankshaft 6 and one toggle link 11, 12 of the toggle lever assembly 4 are respectively connected into a universal joint 13, 14. The ball-and-socket joints 7, 8 feature crank pins 15, 16 that are symmetrically distributed over the circumference of the crankshaft 6 and the moving paths of which extend in a common plane of rotation. The framework 1 and the tool receptacle 2 liftably held therein in accordance with the arrow 17 are connected to one another by means of a vertical guide that is composed of four telescopic guides 18, 19 defining the framework 1. The arrow 20 elucidates the translatory reciprocating motion of the crankshaft 6.

FIG. 2 shows a side view of the lifting device during a lifting motion, in which the crank drive 5 is turned between its end positions realized in the dead centers by approximately 90° and the toggle lever assembly 4 in moved centrally between its extended end position and its bent end position. Identical components are identified by the same reference symbols.

FIG. 3 shows a side view of the lifting device in an operating position, in which the toggle lever assembly 4 is in an extended dead center position. The extended dead center position of the toggle lever assembly 4 is realized such that it is turned by a rotational angle of 180° referred to the buckled dead center position illustrated in FIG. 1. Identical components are also identified by the same reference symbols in this case.

FIG. 4 shows a perspective representation of the lifting device according to FIG. 3, however, with a partially sectioned displacement transducer 3 and a partially sectioned crankshaft 6. The perspective representation clearly shows that the connecting rods 9 have an arc-shaped longitudinal extent and that the ends of the connecting rods that face away from the crankshaft 6 and one of the toggle links 11, 12 of the toggle lever assembly 4 are respectively connected into the universal joints 13, 14. The arrow 20 elucidates the translatory reciprocating motion of the crankshaft 16, the rotational axis of which extends perpendicular to the link axes of the two toggle links 11, 12.

1. A lifting device for a tool, particularly for a lower tool of a thermoformer or traysealer, with a framework, at least one tool receptacle that is liftably held in the framework and at least one displacement transducer that is arranged between the framework and the tool receptacle, wherein:
the framework and the tool receptacle are connected to one another by means of at least one toggle lever assembly, and
the displacement transducer features at least one crank drive that engages on the toggle lever assembly.

2. The lifting device according to claim 1, wherein the crank drive has two end positions that are respectively realized in the region of a dead center.

3. The lifting device according to claim 2, wherein the toggle lever assembly has an extended end position, and in that the extended end position of the toggle lever assembly is realized in one of the dead center positions of the crank drive.

4. The lifting device according to claim 2, wherein the toggle lever assembly has a bent end position, and in that the bent end position of the toggle lever assembly is realized in one of the dead center positions of the crank drive.

5. The lifting device according to claim 1, wherein the crank drive features at least one crankshaft, as well as at least two connecting rods that are respectively coupled to the crankshaft by means of a ball-and-socket joint.

6. The lifting device according to claim 5, wherein the ends of the connecting rods that face away from the crankshaft and one toggle link of the toggle lever assembly are respectively connected into a universal joint.

7. The lifting device according to claim 5, wherein the ball-and-socket joints feature crank pins that are symmetrically distributed over the circumference of the crankshaft and the moving paths of which extend in a common plane of rotation.

8. The lifting device according to claim 5, wherein the crank drive is assigned at least one step motor that is connected to its crankshaft.

9. The lifting device according to claim 8, wherein the step motor is a high-torque motor.

10. The lifting device according to claim 1, wherein the framework and the tool receptacle liftably held therein are connected to one another by means of a vertical guide.

11. The lifting device according to claim 6, wherein the rotational axis of the crank drive and link axes of the toggle links extend perpendicular to one another.
